(19) United States
(12) Patent Application Publication
(10) Pub. No.: US 2026/0129642 A1
(43) Pub. Date: May 7, 2026

(54) SMALL DATA TRANSMISSION IN CASE OF DYNAMIC ADAPTATION OF A SYNCHRONIZATION SIGNAL BLOCK

(71) Applicant: QUALCOMM Incorporated, San Diego, CA (US)

(72) Inventors: Mohammed JABI, San Diego, CA (US); Ahmed Attia ABOTABL, San Diego, CA (US); Diana MAAMARI, San Diego, CA (US)

(21) Appl. No.: 18/936,576

(22) Filed: Nov. 4, 2024

(51) Int. Cl. H04W 72/21; H04L 5/00

(52) U.S. Cl. CPC H04W 72/21; H04L 5/0051

(57) ABSTRACT

Certain aspects of the present disclosure provide techniques for obtaining a configuration indicating a set of physical uplink shared channel (PUSCH) occasions, wherein one or more first PUSCH occasions, of the set of PUSCH occasions, are invalid in accordance with a synchronization signal block (SSB) conflict associated with a first SSB configuration; obtain a dynamic update indicating a second SSB configuration, wherein one or more second PUSCH occasions, of the set of PUSCH occasions, are invalid in accordance with the second SSB configuration; and sending at least one PUSCH transmission using at least one valid PUSCH occasion of the set of PUSCH occasions in accordance with the configuration.

### INTRODUCTION

### Field of the Disclosure

Aspects of the present disclosure relate to wireless communications, and more particularly, to techniques for dynamic adaptation of a synchronization signal block (SSB).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes obtaining a configuration indicating a set of physical uplink shared channel (PUSCH) occasions, wherein one or more first PUSCH occasions, of the set of PUSCH occasions, are invalid in accordance with a synchronization signal block (SSB) conflict associated with a first SSB configuration; obtaining a dynamic update indicating a second SSB configuration, wherein one or more second PUSCH occasions, of the set of PUSCH occasions, are invalid in accordance with the second SSB configuration; and sending at least one PUSCH transmission using at least one valid PUSCH occasion of the set of PUSCH occasions in accordance with the configuration.

Another aspect provides a method for wireless communications by a network entity (NE). The method includes sending a configuration indicating a set of PUSCH occasions, wherein one or more first PUSCH occasions, of the set of PUSCH occasions, are invalid in accordance with a SSB conflict associated with a first SSB configuration; sending a dynamic update indicating a second SSB configuration, wherein one or more second PUSCH occasions, of the set of PUSCH occasions are invalid in accordance with the second SSB configuration; and obtaining at least one PUSCH transmission using at least one valid PUSCH occasion of the set of PUSCH occasions in accordance with the configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of valid and invalid physical uplink shared channel (PUSCH) occasions based on synchronization signal block (SSB) periodicity.

FIG. 6 depicts an example of valid and invalid PUSCH occasions based on a shorter SSB periodicity.

FIG. 7 depicts an example of SSB dynamic adaptation reducing SSB periodicity and its interactions with PUSCH occasions.

FIG. 8 depicts another example of SSB dynamic adaptation reducing SSB periodicity and its interactions with PUSCH occasions.

FIG. 9 depicts an example of SSB dynamic adaptation increasing SSB periodicity and its interactions with PUSCH occasions.

FIG. 10 depicts another example of SSB dynamic adaptation increasing SSB periodicity and its interactions with PUSCH occasions.

FIG. 11 depicts a process flow for communications in a network between an NE and a UE.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for Dynamic adaptation of an SSB.

Telecommunications technologies such as fifth-generation New Radio (5G NR, or simply 5G) may allow a user equipment (UE) to be in one of multiple states to reduce energy consumption, delays, and consumption of compute resources. For example a UE may enter into a radio resource control (RRC) idle state (RRC_IDLE, or simply RRC idle), an RRC connected state (RRC_CONNECTED, or simply RRC connected), or an RRC inactive state (RRC_INACTIVE, or simply RRC inactive), and may transition between these different states.

The RRC connected state may be a state where the UE may communicate directly with the network for data transfer and signaling via an active connection. This state may support application data exchange and network control tasks such as handovers. The RRC idle state may be a low-activity state designed to conserve battery life and manage UE mobility without active communication. In this state, the UE may not be actively engaged in data transfer but may still receive system information and paging messages. The RRC inactive state may be an intermediate state between the RRC connected state and the RRC idle state, and may balance battery efficiency and quick resumption of activity. The RRC inactive state may allow the UE to enter sleep mode and conserve battery life. This state may enable the UE to suspend its connection while remaining registered with the network, which may allow rapid reactivation. Therefore, the RRC inactive state may allow a faster transition to RRC connected state compared to the RRC idle state, because in the RRC inactive state a UE context may be maintained by both the network and the UE, allowing the core network connection to be maintained.

Furthermore, the UE in the RRC inactive state may undertake small data transmissions (SDT), which may allow the UE to transmit data while it remains in the RRC inactive state without having to switch to the RRC connected state. Traditionally, a UE would need to transition to the RRC connected state, which involves a signaling procedure, to send data. This transitioning process to the RRC connected state may include resource overhead (compute or signaling resources) making it inefficient for small data transmissions. SDT in the RRC inactive state therefore allows data to be sent while the UE remains in the RRC inactive state, reducing the need for extensive signaling and thus saving power and improving efficiency.

“SDT” refers to transmission of small amounts of data by the UE without the need to establish a full data connection. SDT may be useful for a UE with regular payloads of data that are relatively small compared to the controlling signal(s) required to transition to the RRC connected state. For example, SDT may be particularly useful for IoT devices that frequently send small data packets, since SDT may reduce signaling overhead and power consumption at these IoT devices.

There are various mechanisms to support SDT in the RRC inactive state. A first mechanism is based on a random access channel (RACH) procedure where a payload is transmitted during a RACH procedure. A second mechanism supports SDT by using preconfigured grant-based physical uplink shared channel (PUSCH) resources. These preconfigured PUSCH resources are configured with configuration parameters including resource blocks, periodicity, time offset, and modulation and coding scheme (MCS), and are configured for the UE during its RRC connected state. This allows the UE to transition to the RRC inactive state and utilize the configuration parameters to perform an SDT transmission. The preconfigured PUSCH resources may be referred to as PUSCH occasions.

Traditionally, synchronization signal block (SSB) transmission may be semi-static and only infrequently changed after being configured. For example, SSB signals may be configured by a system information block, such as system information block 1 (SIB1) or ServingCellConfigCommon configurations, and subsequent reconfiguration of an SSB may be expected to be infrequent.

In some examples, SSBs may be dynamically adapted. Examples of dynamically adapting SSBs may include adjustments in SSB burst periodicity, adjustments to transmissions of SSB bursts, non-uniform skipping of SSBs or SSB bursts, or adapting a number of SSBs within an SSB burst. These adaptations may include SSB changes over a temporal or a time domain allowing a network entity to adjust the SSB based on contextual or performance factors, such as signal strength or quality, efficiency of compute resource use, or energy use. Benefits of dynamic SSB adaptation include energy savings and improvements in energy efficiency. For example, dynamic SSB adaptation may allow a network entity to adjust the SSB to reduce power consumption by transmitting the SSB less often or transmitting fewer instances of the SSB. Conversely, the network entity may increase a frequency of transmission of an SSB, thereby reducing latency associated with UEs receiving the SSB. A dynamic adaptation of a first SSB configuration may be referred to as a dynamic update indicating a second SSB configuration.

PUSCH occasion may conflict with SSB signals, which may be referred to herein as SSB conflicts. For example, a resource for an SSB may collide with the PUSCH signals or a PUSCH occasion associated with a PUSCH occasion. For example, an SSB conflict between an SSB signal and a PUSCH occasion may occur when the transmissions are configured to occur simultaneously or on the same time slot(s), or occur partially simultaneously or over the same time slot(s) (e.g., with a partial overlap). However, in certain instances an SSB conflict may occur based on predefined rules or criteria. For example, an SSB conflict may also be defined herein as including when the PUSCH occasion and the SSB signal are within a predefined number of symbols of each other (where the predefined number of symbols may be referred to as N_gap). In certain instances, SSB signals may be given priority over PUSCH occasions in an RRC inactive state. Thus, in a situation where an SSB conflict occurs between an SSB signal and a PUSCH occasion, a UE may generally receive the SSB instead of transmitting a PUSCH transmission on the PUSCH occasion.

Furthermore, in some deployments, these collision rules between a PUSCH in an RRC inactive state and an SSB consider only the set of SSB occasions exclusively configured via SIB1 or ServingCellConfigCommon. As the dynamic adaptation of SSB configuration is expected to be performed more frequently and in a dynamic way using faster mechanisms (e.g. using DCI if the UE is in RRC active state and via other signaling such as a paging messaged in case the UE is in inactive state), for a PUSCH resource that was considered invalid, resources may be wasted in case the PUSCH occasion becomes valid after the adjustment of the SSB configuration. For example, the PUSCH occasion may still be considered invalid even though the collision that rendered the PUSCH occasion has been resolved.

It is beneficial for a UE and network entity to know when an SSB conflict may occur, so that the UE and network entity can plan around the SSB conflict. However, dynamic SSB adaptation may lead to a situation where more or fewer SSBs are transmitted relative to a baseline configuration (such as a configuration provided via SIB1 or ServingCellConfigCommon). Such a change in a frequency or number of SSBs transmitted may lead to a change in SSB conflicts between PUSCH occasions and SSBs. For example, the number of SSBs may increase, leading to a situation where additional PUSCH occasions collide with SSBs. As another example, the number of SSBs may decrease, leading to a situation where previously-colliding (and thus invalid) PUSCH occasions no longer collide with an SSB. Without a common understanding of whether these PUSCH occasions are valid or invalid, resources may be allocated inefficiently or PUSCH transmissions may be missed.

The technologies disclosed herein present apparatuses, systems, and methods to resolve SSB conflicts that arise between a dynamically adapted SSB configuration and PUSCH occasions. For example, a PUSCH occasion may be invalid under a first SSB configuration due to an SSB conflict on the PUSCH occasion, and a second SSB configuration (associated with a dynamic update) may eliminate the SSB conflict that was present under the first SSB configuration. In some aspects, even if the PUSCH occasion would otherwise be valid under the second SSB configuration, the PUSCH occasion may nonetheless be invalidated in accordance with the first SSB configuration. This deferral (after the dynamic update indicating the second SSB configuration) to validation or invalidation under the first SSB configuration provides technical benefits including allowing simultaneous operation of more than one SSB configuration. This adds flexibility to UEs that may not be capable of fully utilizing a dynamically updated SSB configuration and allows the updated SSB configuration to defer to the first SSB configuration where uplink transmission is deprioritized.

Aspects disclosed herein additionally, or alternatively, include one or more first PUSCH occasions that were invalid under a first SSB configuration being considered valid in accordance with a second SSB configuration. For example, PUSCH occasions that were invalid under a first SSB configuration due to an SSB conflict may be considered valid under the second SSB configuration where there is no SSB conflict on the PUSCH occasions. This provides the technical benefit of reducing conflicts between SSB and PUSCH occasions, reducing interruptions to uplink transmissions from the UE, which could lead to lower latencies and higher throughputs.

In some aspects, one or more second PUSCH occasions that were valid in accordance with the first SSB configuration may become invalid under the second SSB configuration. For example, PUSCH occasions that were valid under the first SSB configuration may be considered invalid under a second SSB configuration due to an SSB conflict on the PUSCH occasions. In these instances, SSBs are transmitted more often, thereby reducing synchronization latency between the UE and the NE.

In some aspects, a PUSCH occasion that was valid under the first SSB configuration remains valid even if an SSB conflict arises under the second SSB configuration. For example, an SSB may be invalidated when conflicting with a PUSCH due to a dynamic update of the SSB's SSB configuration. This provides the technical benefit of prioritizing UE communications over NE transmissions, which leads to increasing upload rates and elimination of interruptions to UE transmissions, which could lead to lower latencies.

A technical benefit of resolving these SSB conflicts is that the UE and the network entity may have a common understanding of which PUSCH occasions are valid, thereby reducing the occurrence of missed PUSCH transmissions or unnecessary (invalid) PUSCH transmission. Another technical benefit of resolving SSB conflicts associated with dynamic adaptations may include reduction or elimination of SSB conflict or other resource conflicts, where two signals attempt to utilize the same resource. This frees up resources and may allow connection(s) between a UE and a network to run efficiently and without any interruptions to a transmission signal reducing delays. Furthermore, the UE or network can take advantage of freed up resources that were taken up by and now released from a previous SSB signal by the dynamic adaptations. This freeing up of resources may be identified and exploited to allow additional signals to be transmitted increasing throughput or contributing to reductions in latency. Thus, collision rules are defined that take into account the dynamic adaptation of the SSB configuration and that consider an active or most recent SSB configuration, irrespectively of how the SSB configuration is shared with the UE (even if the SSB configuration was not received via SIB1 or ServingCellConfigCommon).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

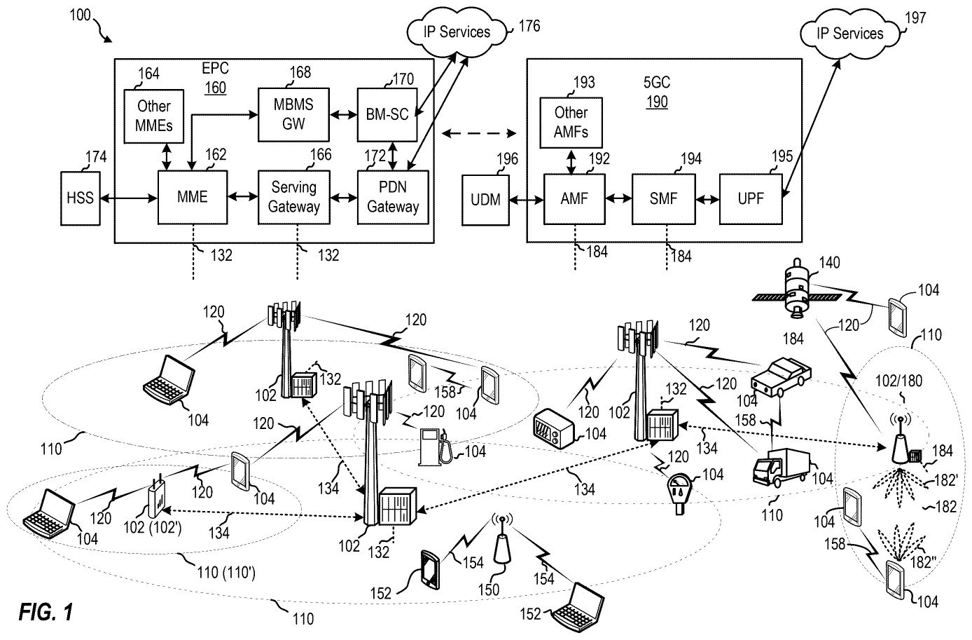

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

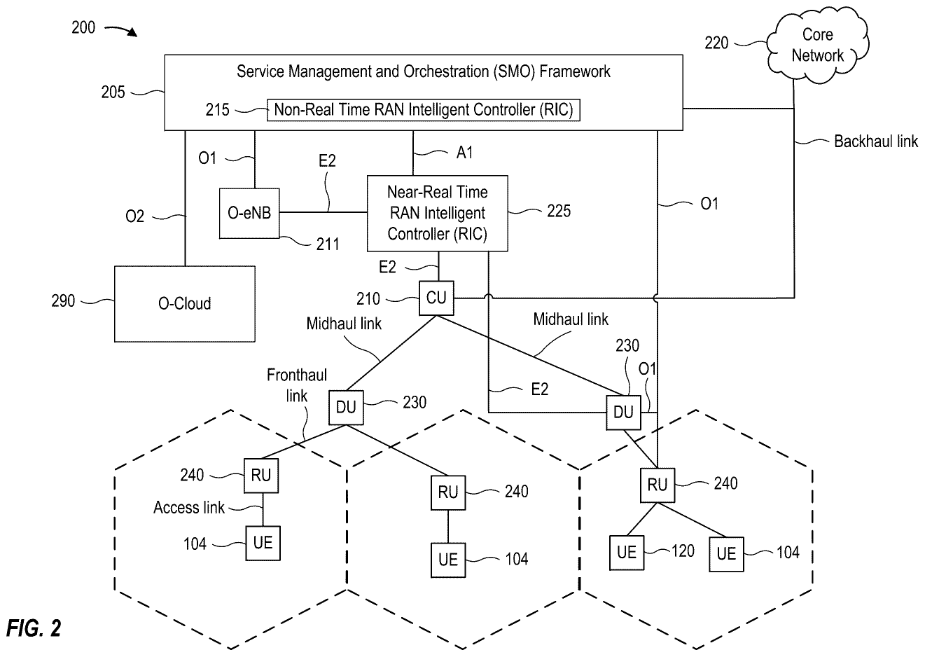

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz - 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a Wi-Fi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

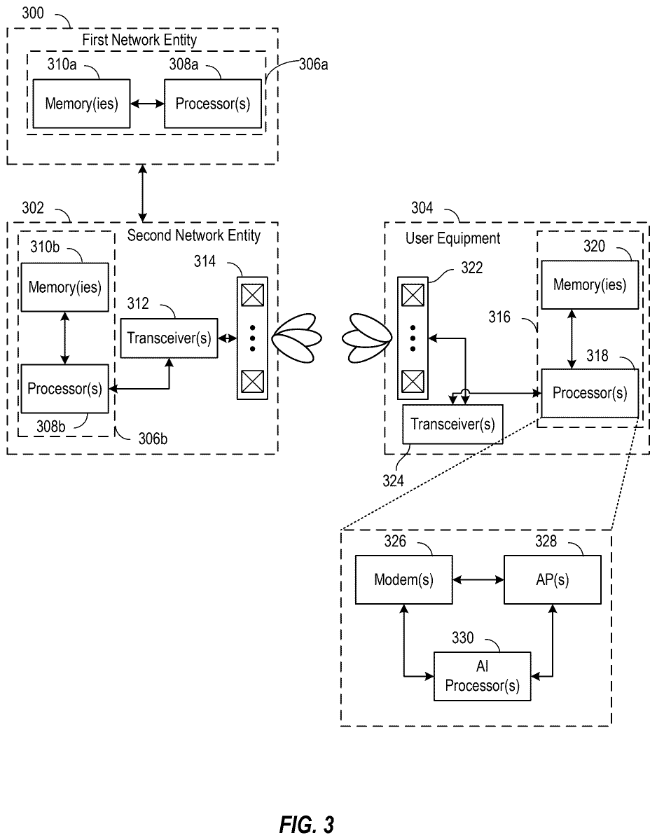

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

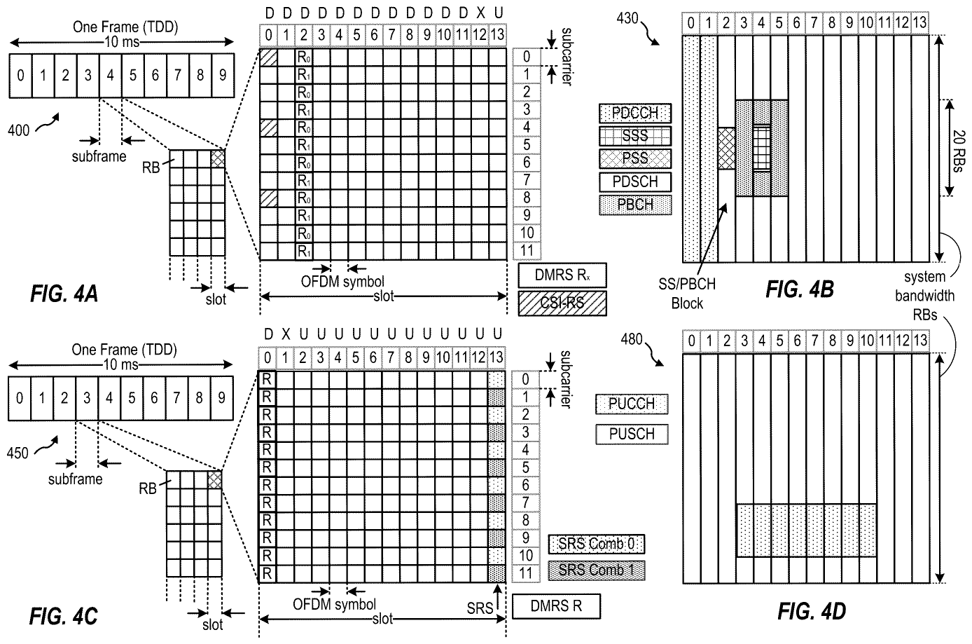

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Adaptation of SSBs

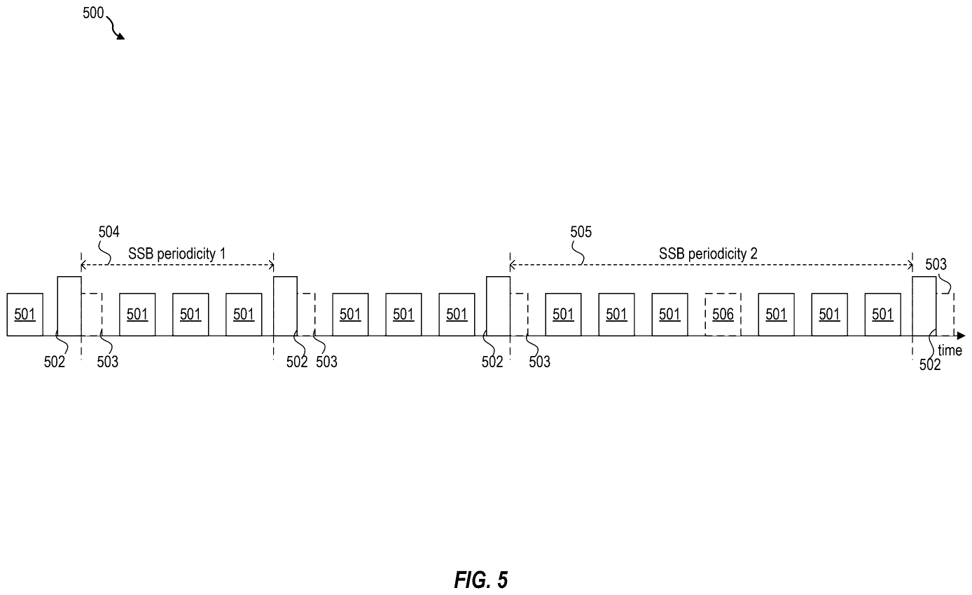

FIG. 5 depicts an example 500 of valid and invalid PUSCH occasions based on SSB periodicity. Example 500 depicts two SSB periodicities, the effects of each periodicity on SSB conflicts, and the effects of substituting one SSB periodicity with another. Example 500 further depicts the effects of replacing a shorter SSB periodicity with a longer SSB periodicity and the subsequent effects on PUSCH occasions including PUSCH occasions that become unresolved PUSCH occasions.

In some aspects, in example 500 an SSB configuration and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

In some aspects, example 500 may depict PUSCH occasions when the UE is in an RRC inactive state. In some aspects, the RRC inactive state allows SDT on the PUSCH occasions. In some aspects, the PUSCH occasions comprise Type-1 grant PUSCH occasions requested by the UE in an RRC connected state. A Type-1 grant PUSCH occasion may use an uplink grant configuration (e.g., a PUSCH configuration) with activation and deactivation of the uplink grant configuration provided via RRC signaling.

In some aspects, the example 500 comprises valid PUSCH occasions 501, invalid PUSCH occasions 503, and unresolved PUSCH occasions 506 (referred to collectively simply as PUSCH occasions). A valid PUSCH occasion 501 may be considered active. A valid PUSCH occasion 501 may be used for a PUSCH transmission, and thus may be referred to as an active PUSCH occasion. An invalid PUSCH occasion 503 may be considered inactive (for example, due to an SSB conflict, as described below). An inactive PUSCH occasion may not be used for a PUSCH transmission, and thus may be referred to as an invalid PUSCH occasion. Techniques are described herein for determining whether an unresolved PUSCH occasion 506 should be considered valid (and therefore used as a valid PUSCH occasion) or invalid (and therefore used as an invalid PUSCH occasion).

The example 500 also comprises SSBs 502. A first SSB periodicity 504 indicates an initial periodicity between SSBs 502 (such as according to a first SSB configuration). A second SSB periodicity 505 depicts a subsequent periodicity between SSBs 502 (such as according to a second SSB configuration obtained via a dynamic update). An SSB periodicity represents a time gap between SSBs. Therefore, a longer SSB periodicity provides a larger time gap between the SSBs 502. In some aspects, an SSB 502 may represent an SSB burst. The first SSB periodicity 504 may be configured by an SSB configuration. An SSB configuration may be received via SIB1 or ServingCellConfigCommon. The PUSCH occasions may be grant-based PUSCH occasions that may be configured by a PUSCH configuration.

The shorter periodicity of the first SSB periodicity 504 results in a higher frequency of the SSBs 502 since the time gaps between the SSBs 502 are smaller. Similarly, the second SSB periodicity 505 with a longer periodicity than the periodicity of the first SSB periodicity 504 causes longer delays between SSBs 502 due to larger time gaps between the SSBs 502. In example 500, the second SSB periodicity 505 is twice as long as the first SSB periodicity 504.

The periodicity of SSBs affects SSB conflicts between PUSCH occasions and SSB occasions. Under the first SSB periodicity 504, the SSBs 502 conflict with PUSCH occasions 503 at every fourth PUSCH occasion. The invalid PUSCH occasions 503 are invalid due to conflicting with the SSB 502. Under the second SSB periodicity 505, the SSBs 502 conflict with PUSCH occasions at every eighth PUSCH occasion. The PUSCH occasions at every eighth PUSCH occasion are thus considered invalid PUSCH occasions 503.

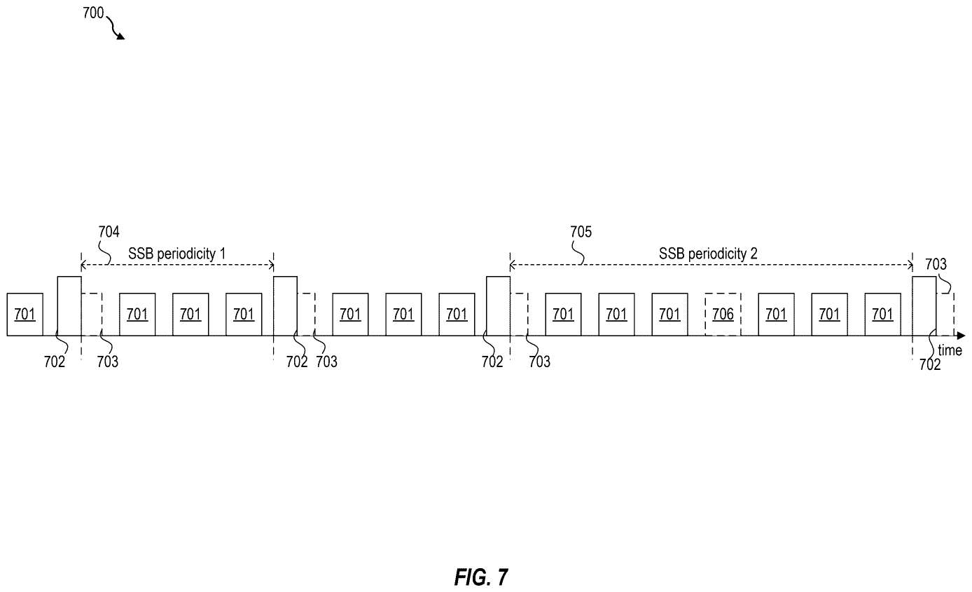

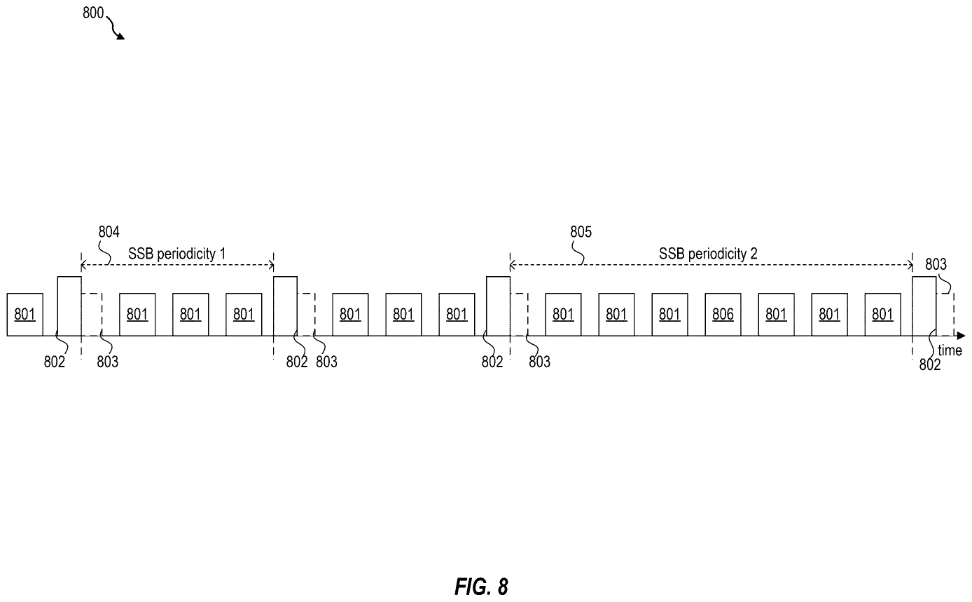

However, unresolved PUSCH occasions 506 (which would be treated as invalid based on the first SSB periodicity 504) do not conflict with the SSBs 502 under the second SSB periodicity 505. Aspects described herein, such as with respect to FIGS. 7 and 8, provide examples of whether or not unresolved PUSCH occasions 506 are considered active (valid) or inactive (invalid).

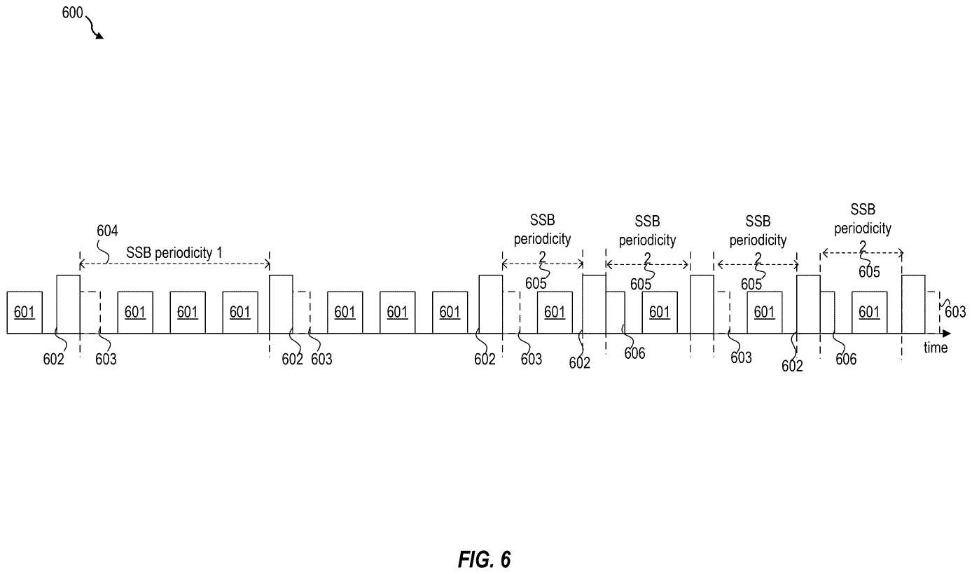

FIG. 6 depicts an example 600 of valid and invalid PUSCH occasions based on a shorter SSB periodicity. Example 600 depicts two SSB periodicities, the effects of each periodicity on SSB conflicts, and the effects of substituting one SSB periodicity with another. Example 600 further depicts the effects of replacing a longer SSB periodicity with a shorter SSB periodicity and the subsequent effects on PUSCH occasions including PUSCH occasions that become unresolved PUSCH occasions. FIGS. 7-10 provide “resolution” of unresolved PUSCH occasions, such as determination of whether an unresolved PUSCH occasion of FIGS. 5 and 6 should be treated as valid or invalid.

In some aspects, in example 600, an SSB configuration and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

In some aspects, example 600 may depict PUSCH occasions when the UE is in an RRC inactive state. In some aspects, the RRC inactive state allows SDT via the PUSCH occasions. In some aspects, the PUSCH occasions comprise Type-1 grant PUSCH occasions requested by the UE in an RRC connected state. A Type-1 grant PUSCH occasion may use an uplink grant configuration (e.g., a PUSCH configuration) with activation and deactivation of the uplink grant configuration provided via RRC signaling.

In some aspects, the example 600 comprises valid PUSCH occasions 601, invalid PUSCH occasions 603, and unresolved PUSCH occasions 606 (referred to collectively simply as PUSCH occasions).

The example 600 also comprises SSBs 602. A first SSB periodicity 604 indicates an initial periodicity between SSBs 602 (such as according to a first SSB configuration). A second SSB periodicity 605 depicts a subsequent periodicity between SSBs 602 (such as according to a second SSB configuration obtained via a dynamic update). A periodicity represents a time gap between SSBs. Therefore a shorter periodicity is associated with a shorter time gap between the SSBs 602. In some aspects, an SSB 602 may represent an SSB burst.

The first SSB periodicity 604 may be configured by an SSB configuration. The SSB configuration may be received via SIB1 or ServingCellConfigCommon. The PUSCH occasions may be grant-based PUSCH occasions that may be configured by a PUSCH configuration.

The first SSB periodicity 604 has a longer periodicity than the second SSB periodicity 605, resulting in a lower frequency of the SSBs 602 since the time gaps between the SSBs 602 are larger. Similarly, the second SSB periodicity 605 with a shorter periodicity than the periodicity of the first SSB periodicity 604 causes shorter delays between SSBs 602 due to smaller time gaps between the SSBs 602. In example 600, the second SSB periodicity 605 is half the length of the first SSB periodicity 604.

The periodicity of SSBs affects conflicts between PUSCH occasions and SSBs 602. Under the first SSB periodicity 604, the SSBs 602 conflict with PUSCH occasions 603 at every fourth PUSCH occasion. The invalid PUSCH occasion 603 is invalid due to conflicting with the SSB 602. Under the second SSB periodicity 605, the SSBs 602 conflict with PUSCH occasions at every second PUSCH occasion.

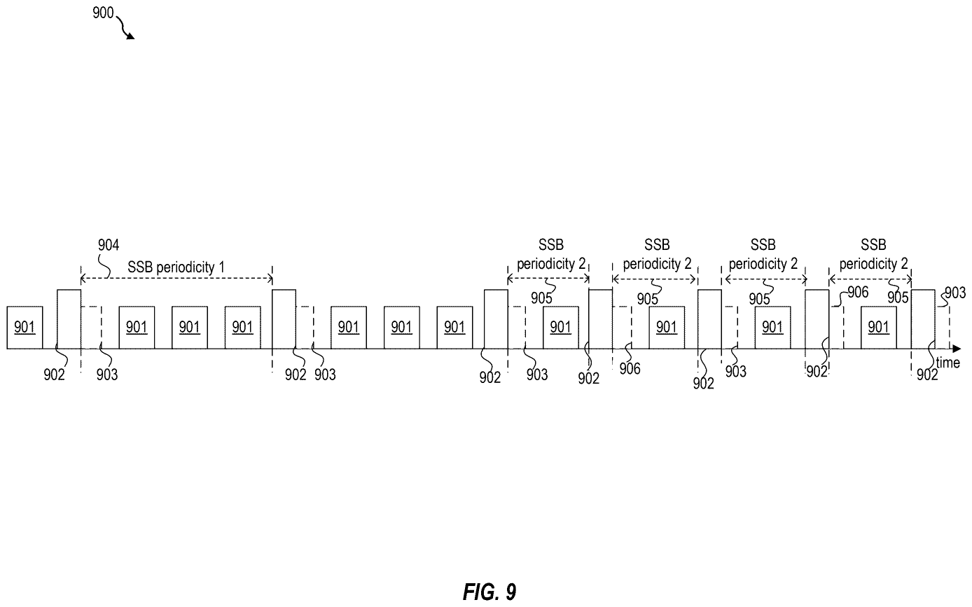

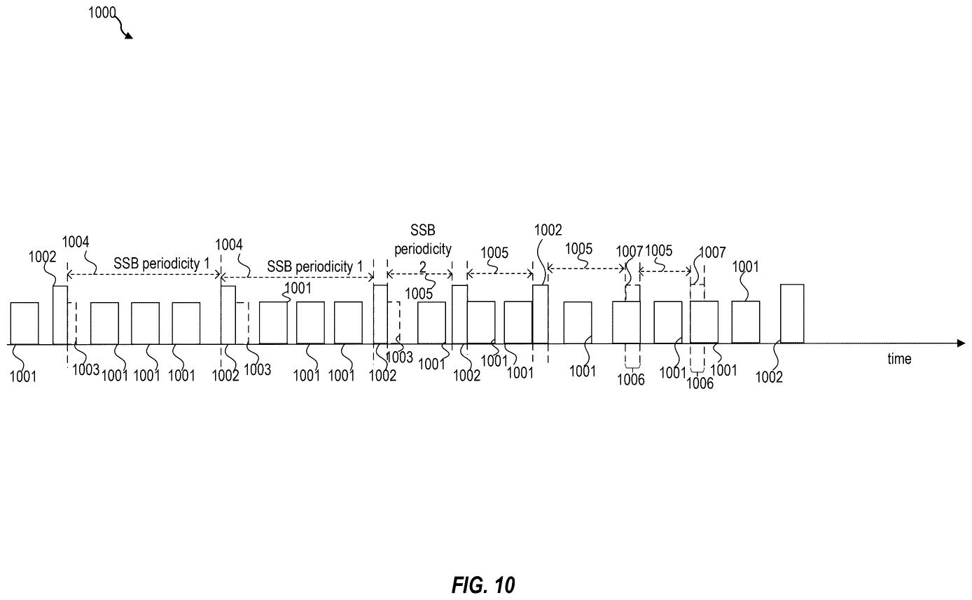

Unresolved PUSCH occasions 606 (which would be treated as valid based on the first SSB periodicity 604), come in SSB conflict with the SSBs 602 under the second SSB periodicity 605 and should be invalid but remain unresolved. Aspects described herein, such as with respect to FIGS. 9 and 10, provide examples of whether or not unresolved PUSCH occasions 606 are considered valid (active) or invalid (inactive).

### Aspects Related to Resolving SSB Conflicts Associated With Dynamic Adaptation of SSBs

FIG. 7 depicts an example 700 of SSB dynamic adaptation and resolving SSB conflicts. The example 700 depicts resolving an SSB conflict associated with the dynamic adaptation of SSBs on PUSCH occasions with a first approach. In the first approach, a PUSCH occasion that is invalid in an RRC inactive state according to a first SSB configuration (such as an SSB configuration received via SIB1 or ServingCellConfigCommon) is considered to remain invalid even if, according to a second SSB configuration (such as a dynamically adapted SSB configuration), the PUSCH occasion would become valid.

In some aspects, in example 700 SSB configurations and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

The example 700 comprises two example SSB periodicities 704 and 705 that are each associated with a separate SSB configuration. The first SSB periodicity 704 is associated with a first SSB configuration and the second SSB periodicity 705 is associated with a second SSB configuration. The first SSB configuration may be dynamically updated by the second SSB configuration, for example, to improve NE energy efficiency and performance. In some aspects, the first SSB configuration may be received via SIB1 or ServingCellConfigCommon. In some aspects, if the UE is in RRC connected state (or governed by dynamic grant), the NE may dynamically update the first SSB configuration to the second SSB configuration through DCI. In some aspects, when the UE is in an RRC inactive state, the NE may dynamically update the first SSB configuration to the second SSB configuration via an RRC release message or a paging message. For example, the second SSB configuration may be received dynamically, or be dynamically indicated by an NE in any suitable fashion. For example, the NE may transmit, and the UE may receive, a dynamic update that indicates the second SSB periodicity 705. In some aspects, the second SSB configuration may adjust the first SSB periodicity 704 to implement the second SSB periodicity 705. In some examples, “being received dynamically” or “dynamically indicated” excludes being received or indicated via SIB1 or ServingCellConfigCommon. In such examples, an active SSB configuration is considered for the purpose of collision resolution, irrespective of how the active SSB configuration is signaled to the UE (e.g., irrespective of whether the active SSB configuration is signaled via SIB1, ServingCellConfigCommon, or a dynamic adaptation), as described below.

The second SSB configuration may adjust the first SSB configuration by omitting at least one SSB burst, adding at least one SSB burst, adding a new compact SSB burst, adjusting the number of SSB signals within an SSB burst, adapting a position of SSBs within an SSB burst, adjusting a cellular discontinuous transmission (cell DTX) configuration of an SSB, or changing the periodicity of SSBs (e.g., adjusting the length from the first SSB periodicity 704 to the second SSB periodicity 705). As described herein an SSB burst may comprise a number of SSBs transmitted periodically (e.g., the number of SSBs within an SSB periodicity such as the first SSB periodicity 704 or the second SSB periodicity 705). By comparison the SSB periodicity defines the time period within which SSBs are transmitted as a burst within a periodicity. While a single SSB 702 is illustrated, in some aspects, the SSB 702 may represent an SSB burst. An SSB burst may be referred to as a synchronization signal (SS) burst.

In some aspects, example 700 may depict PUSCH occasions when the UE is in an RRC inactive state. In some aspects, the RRC inactive state allows SDT via the PUSCH occasions. In some aspects, the PUSCH occasions comprise Type-1 grant PUSCH occasions requested by or configured for the UE in an RRC connected state. A Type-1 grant PUSCH occasion may use an uplink grant configuration (e.g., a PUSCH configuration) with activation and deactivation of the uplink grant configuration provided via RRC signaling.

In some aspects, the example 700 comprises valid PUSCH occasions 701, invalid PUSCH occasions 703, and resolved PUSCH occasions 706 (referred to collectively simply as PUSCH occasions). The resolved PUSCH occasions 706 (and other resolved PUSCH occasions described herein) are referred to as “resolved” PUSCH occasions because aspects described herein provide for resolution of whether such a PUSCH occasion is considered valid or invalid when dynamic adaptation of an SSB configuration affects the PUSCH occasion.

In some aspects, the example 700 comprises SSBs 702. The first SSB periodicity 704 depicts an initial periodicity between SSBs 702. The second SSB periodicity 705 depicts a subsequent periodicity between SSBs 702.

The shorter periodicity of the first SSB periodicity 704 results in a higher frequency of the SSBs 702 since the time gaps between the SSBs 702 are smaller. Similarly, the second SSB periodicity 705 with a longer periodicity than the periodicity of the first SSB periodicity 704 causes longer delays between SSBs 702 due to larger time gaps between the SSBs 702. In example 700 the second SSB periodicity 705 is twice as long as the first SSB periodicity 704.

The periodicity of SSBs affects conflicts between PUSCH occasions and SSB occasions. Under the first SSB periodicity 704 associated with a first SSB configuration, the SSBs 702 conflict with PUSCH occasions at every fourth PUSCH occasion, which may be represented by invalid PUSCH occasions 703. This conflicting PUSCH occasion may be represented by the invalid PUSCH occasions 703. The invalid PUSCH occasions 703 are inactive due to conflicting with the SSBs 702. Under the second SSB periodicity 705 which is twice as long as the first SSB periodicity 704, the SSBs 702 conflict with PUSCH occasions at every eighth PUSCH occasion. The PUSCH occasions at every eighth PUSCH occasion are deactivated to become invalid PUSCH occasions 703.

In example 700, the valid PUSCH occasions 701 are associated with no SSB conflict in accordance with the second SSB configuration, but remain inactive for the second SSB configuration as resolved PUSCH occasions 706 in accordance with the SSB conflicts associated with the first SSB configuration (e.g., the resolved PUSCH occasions 706 under the second SSB periodicity 705 correspond with invalid PUSCH occasions 703 that are invalid under the first SSB periodicity 704). The second SSB configuration may be dynamically indicated changing the second SSB periodicity and therefore the frequency of the SSB conflicts. A PUSCH occasion may have no conflict with an SSB under the second SSB configuration, but validity of the PUSCH occasion is determined under the first SSB configuration, so the PUSCH occasion is treated as if there is an SSB conflict (and thus determined to be invalid).

In example 700, the second SSB configuration may defer to the first SSB configuration. Therefore, the resolved PUSCH occasion 706 is invalid based on the first SSB configuration and/or the first SSB periodicity 704, even if under the second SSB configuration and the second SSB periodicity 705, there is no actual SSB conflict with the SSBs 702. This is because under the example 700, the PUSCH configuration is still based on the first SSB periodicity 704 of the first SSB configuration.

FIG. 8 depicts another example 800 of SSB dynamic adaptation reducing SSB periodicity and its interactions with PUSCH occasions. The example 800 depicts resolving an SSB conflict associated with the dynamic adaptation of SSBs on PUSCH occasions with a second approach. In the second approach, a PUSCH occasion that is invalid in an RRC inactive state according to a first SSB configuration (such as an SSB configuration received via SIB1 or ServingCellConfigCommon) becomes valid if, according to a second SSB configuration (such as a dynamically adapted SSB configuration), the PUSCH occasion would become valid.

In some aspects, in example 800, SSB configurations and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

The example 800 comprises two example SSB periodicities 804 and 805. The first SSB periodicity 804 is associated with a first SSB configuration and the second SSB periodicity 805 is associated with a second SSB configuration. The first SSB periodicity 804 and the second SSB periodicity 805 may be signaled as described with regard to FIG. 7. In some aspects, the second SSB configuration may adjust the first SSB periodicity 804 to implement the second SSB periodicity 805. For example, the second SSB configuration may adjust the first SSB configuration as described in connection with FIG. 7 to lengthen the SSB periodicity. In some aspects, an SSB depicted in FIG. 8 may indicate an SSB burst, as described in connection with FIG. 7.

In some aspects, example 800 may depict PUSCH occasions when the UE is in an RRC inactive state. In some aspects, example 800 comprises valid PUSCH occasions 801 and invalid PUSCH occasions 803, and resolved PUSCH occasions 806 (referred to collectively simply as PUSCH occasions).

A valid PUSCH occasion 801 may be considered active. A valid PUSCH occasion 801 may be used for a PUSCH transmission, and thus may be referred to as an active PUSCH occasion. An invalid PUSCH occasion 803 may be considered inactive (for example, due to an SSB conflict, as described below). An invalid PUSCH occasion may not be used for a PUSCH transmission, and thus may be referred to as an invalid PUSCH occasion 803. The resolved PUSCH occasion 806 is referred to as a “resolved” PUSCH occasion because example 800 provides an example of application of a rule indicating whether the resolved PUSCH occasion 806 is valid (active) or invalid (inactive).

The first SSB periodicity 804 depicts an initial periodicity between SSBs 802. The second SSB periodicity 805 depicts a subsequent periodicity between SSBs 802. The first SSB periodicity 804 may have a shorter periodicity than the second SSB periodicity 805, which results in a higher frequency of the SSBs 802 for the first SSB periodicity 804 since the time gaps between the SSBs 802 are smaller. The second SSB periodicity 805 may have a longer periodicity than the periodicity of the first SSB periodicity 804, which causes longer delays between SSBs 802 due to larger time gaps between the SSBs 802. In the example 800 the second SSB periodicity 805 is twice as long as the first SSB periodicity 804.

The periodicity of SSBs affects conflicts between PUSCH occasions and SSB occasions. Under the first SSB periodicity 804 associated with a first SSB configuration, the SSBs 802 conflict with PUSCH occasions at every fourth PUSCH occasion. This conflicting PUSCH occasion may be represented by the invalid PUSCH occasions 803. The invalid PUSCH occasions 803 are invalid due to conflicting with the SSB 802. Under the second SSB periodicity 805, which is twice as long as the first SSB periodicity 804, the SSBs 802 conflict with PUSCH occasions at every eighth PUSCH occasion. The PUSCH occasions at every eighth PUSCH occasion remain invalid PUSCH occasions 803. In example 800, the resolved PUSCH occasions 806 are valid PUSCH occasions 801 in accordance with the second SSB configuration (and the second SSB periodicity 805) even though these PUSCH occasions were invalid PUSCH occasions 803 under the first SSB configuration (and the associated first SSB periodicity 804).

Because the second SSB configuration configures the second SSB periodicity 805 to be twice as long as the first SSB periodicity 804, there is a larger time gap between SSBs 802 and therefore a reduction in the number of SSB conflicts. In some aspects, the resolved PUSCH occasion 806 is valid when the resolved PUSCH occasion 806 would have been invalid based on the first SSB configuration and the first SSB periodicity 804. Under the second SSB periodicity 805, the PUSCH occasions that were in conflict with SSBs 802 under the first SSB periodicity 804 and the first SSB configuration, and are no longer in conflict with the SSBs 802 under the second SSB periodicity 805, are valid under the second SSB configuration. In other words, the validity and invalidity are decided with respect to the most recent active SSB configuration irrespective of how it is received.

FIG. 9 depicts an example 900 of SSB dynamic adaptation increasing SSB periodicity and its interactions with PUSCH occasions. The example 900 depicts resolving an SSB conflict associated with the dynamic adaptation of SSBs on PUSCH occasions with a third approach. In the third approach, a PUSCH occasion that is valid in an RRC inactive state according to a first SSB configuration (such as an SSB configuration received via SIB1 or ServingCellConfigCommon) becomes invalid if, according to a second SSB configuration (such as a dynamically adapted SSB configuration), the PUSCH occasion would become invalid.

In some aspects, in example 900, SSB configurations and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

The example 900 comprises two example SSB periodicities 904 and 905. The first SSB periodicity 904 is associated with a first SSB configuration and the second SSB periodicity 905 is associated with a second SSB configuration. The first SSB periodicity 904 and the second SSB periodicity 905 may be signaled as described with regard to FIG. 7. In some aspects, the second SSB configuration may adjust the first SSB periodicity 904 to implement the second SSB periodicity 905. For example, the second SSB configuration may adjust the first SSB configuration as described in connection with FIG. 7 to shorten the SSB periodicity. In some aspects, an SSB depicted in FIG. 9 may indicate an SSB burst, as described in connection with FIG. 7.

In some aspects, example 900 may depict PUSCH occasions when the UE is in an RRC inactive state. In some aspects, the example 900 comprises valid PUSCH occasions 901, invalid PUSCH occasions 903, and resolved PUSCH occasions 906 (referred to collectively simply as PUSCH occasions).

A valid PUSCH occasion 901 may be considered active. A valid PUSCH occasion 901 may be used for a PUSCH transmission, and thus may be referred to as an active PUSCH occasion. An invalid PUSCH occasion 903 may be considered inactive (for example, due to an SSB conflict, as described below). An inactive PUSCH occasion may not be used for a PUSCH transmission, and thus may be referred to as an invalid PUSCH occasion 903. The resolved PUSCH occasion 906 is referred to as a “resolved” PUSCH occasion because example 900 provides an example of application of a rule indicating whether the resolved PUSCH occasion 906 is valid (active) or invalid (inactive).

The first SSB periodicity 904 depicts an initial periodicity between SSBs 902. The second SSB periodicity 905 depicts a subsequent periodicity between SSBs 902. The first SSB periodicity 904 has a longer periodicity than the second SSB periodicity 905, which results in a lower frequency of the SSBs 902 when using the first SSB periodicity 904 since the time gaps between the SSBs 902 are larger. Similarly, the second SSB periodicity 905 has a shorter periodicity than the periodicity of the first SSB periodicity 904, which causes shorter delays between SSBs 902 due to smaller time gaps between the SSBs 902. In example 900, the second SSB periodicity 905 is half the length of the first SSB periodicity 904.

The periodicity of SSBs affects conflicts between the PUSCH occasions and SSBs 902. Under the first SSB periodicity 904, the SSBs 902 conflict with PUSCH occasions at every fourth PUSCH occasion, which is represented by the invalid PUSCH occasion 903. The invalid PUSCH occasion 903 is inactive due to conflicting with the SSB 902. Under the second SSB periodicity 905, which is half as long as the first SSB periodicity 904, the SSBs 902 conflict with PUSCH occasions at every second PUSCH occasion.

In some aspects, PUSCH occasions are valid in accordance with the first SSB configuration. In some aspects, in the example 900, resolved PUSCH occasions 906 that were valid in accordance with the first SSB configuration become invalid under the second SSB configuration due to SSB conflicts between the resolved PUSCH occasions 906 and SSBs 902. Therefore, the resolved PUSCH occasions 906 that were valid under the first SSB periodicity 904 become invalid based on the second SSB periodicity 905. In other words, the validity and invalidity are decided with respect to the most recent active SSB configuration irrespective of how it is received.

FIG. 10 depicts another example 1000 of SSB dynamic adaptation increasing SSB periodicity and its interactions with PUSCH occasions. The example 1000 depicts resolving an SSB conflict associated with the dynamic adaptation of SSBs on PUSCH occasions with a fourth approach. In the fourth approach, a PUSCH occasion that is valid in an RRC inactive state according to a first SSB configuration (such as an SSB configuration received via SIB1 or ServingCellConfigCommon) stays valid even if, according to a second SSB configuration (such as a dynamically adapted SSB configuration), the PUSCH occasion would become invalid according to legacy techniques.

In some aspects, in example 1000 SSB configurations and a PUSCH configuration configure communications between a UE and an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

The example 1000 comprises two SSB periodicities 1004 and 1005. The first SSB periodicity 1004 is associated with a first SSB configuration and the second SSB periodicity 1005 is associated with a second SSB configuration. In some aspects, the first SSB periodicity 904 and the second SSB periodicity 905 may be signaled as described with regard to FIG. 7. In some aspects, the second SSB configuration may adjust the first SSB periodicity 1004 to implement the second SSB periodicity 1005. For example, the second SSB configuration may adjust the first SSB configuration as described in connection with FIG. 7 to shorten the SSB periodicity. In some aspects, an SSB depicted in FIG. 10 may include an SSB burst, as described in connection with FIG. 7.

In some aspects, example 1000 may depict PUSCH occasions when the UE is in an RRC inactive state. In some aspects, the example 1000 comprises valid PUSCH occasions 1001 and invalid PUSCH occasions 1003 (referred to collectively as PUSCH occasions). In example 1000, a valid PUSCH occasion 1001 that is valid according to the first SSB configuration remains valid after a dynamic update to the second SSB configuration. For example, even if an SSB that occupies a time resource indicated by the second SSB configuration overlaps a valid PUSCH occasion 1001 (as shown, for example, at a time resources 1006), the valid PUSCH occasion 1001 may remain available for PUSCH transmission. In such examples, an SSB 1007 that overlaps a valid PUSCH occasion 1001 may be rendered inactive or dropped (e.g., not transmitted, not monitored for). Therefore, in some aspects, the second SSB configuration prioritizes the PUSCH occasions over SSBs in an SSB conflict over a time resource, e.g., time resources 1006. The SSB 1007 is invalidated or remains inactive, and does not get transmitted from the NE based on the second SSB configuration, nor is it monitored for by the UE based on the second SSB configuration.

The descriptions of the examples 700-1000 of FIGS. 7-10 may implement Type-1 grant based PUSCH transmission in RRC-inactive state. But the descriptions of the examples 700-1000 FIGS. 7-10 may also implement uplink semi-persistent scheduling, e.g., Type-1 grant based PUSCH transmission in RRC connected state.

### Example Signaling of Dynamic Adaptation of SSB

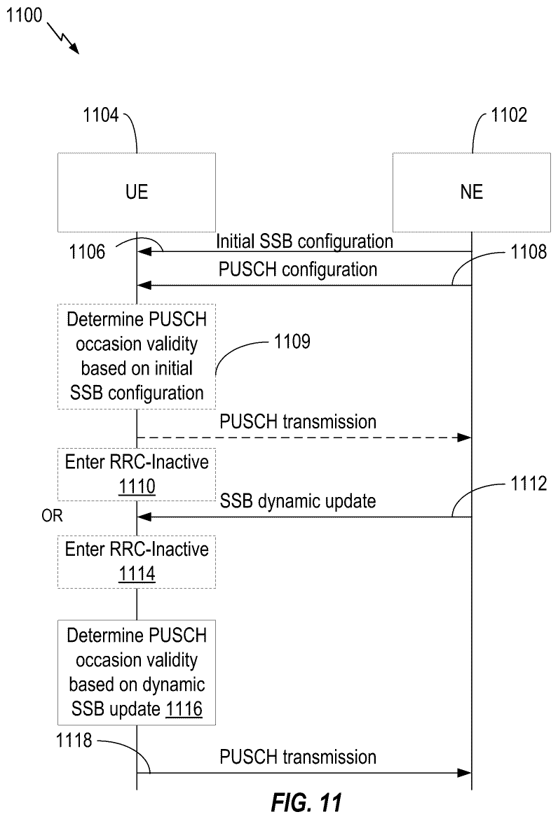

FIG. 11 depicts an example 1100 of a process flow for communications in a network between an NE 1102 and a UE 1104.

The NE may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

In some aspects, the example 1100 may include at 1106 obtaining by the UE 1104 and sending by the NE 1102 an initial SSB configuration (sometimes referred to as a first SSB configuration). The initial SSB configuration may be received via SIB1 or ServingCellConfigCommon. The initial SSB configuration may correspond to the first SSB configuration of FIGS. 5-10, which may respectively be associated with the first SSB periodicity 504, 604, 704, 804, 904, or 1004 of FIGS. 5-10.

In some aspects, the example 1100 may include at 1108 obtaining by the UE 1104 and sending by the NE 1102 a PUSCH configuration indicating a set of PUSCH occasions to allow the UE 1104 to determine PUSCH occasions. In some aspects, at 1109, the UE 1104 may optionally determine validity of these PUSCH occasions according to the initial SSB configuration. For example, the UE 1104 may transmit one or more PUSCHs on the determined PUSCH occasions.

In some aspects, at 1112, the UE 1104 obtains and the NE 1102 sends a dynamic update indicating a second SSB configuration. In some optional aspects, the dynamic update is sent at 1112 as part of an RRC release message to transition the UE 1104 into an RRC inactive state at 1114. In some optional aspects, the UE 1104 is already in an RRC inactive state at 1110 prior to 1112. Thus, two options for entering an RRC inactive state are illustrated: one where the UE is in an RRC inactive state prior to obtaining the dynamic update, and another where the UE receives the dynamic update as part of an RRC release message that then causes the UE to transition to an RRC inactive state.

In some aspects, the SSB dynamic update at 1112 is sent as part of a new indication for a dynamic grant for a new transmission or retransmission (or as part of an NE response to a first uplink message such as a CG transmission on a PUSCH occasion). In some aspects, the SSB dynamic update at 1112 is sent or received through a paging message.

In some aspects, at 1116 the UE 1104 may determine PUSCH occasions based on the dynamic update. For example, the UE 1104 may determine whether a given PUSCH occasion is valid (e.g., active) based on the dynamic update. This determining at 1116 may correspond to identifying resolved PUSCH occasions or invalid SSBs according to the second SSB configuration of FIGS. 7-10, which may respectively be associated with the second SSB periodicity 705, 805, 905, and 1005 of FIGS. 7-10.

In some aspects, at 1118, the UE 1104 sends and the NE 1102 receives at least one PUSCH transmission using at least one valid (e.g., active) PUSCH occasion determined at 1116. In some aspects, the PUSCH transmission is an SDT. In some aspects, the at least one valid PUSCH occasion corresponds to the valid PUSCH occasions 501, 601, 701, 801, 901, and 1001 of FIGS. 5-10, or the resolved PUSCH occasions 706, 806, and 906 of FIGS. 7-9.

### Example Operations of a User Equipment

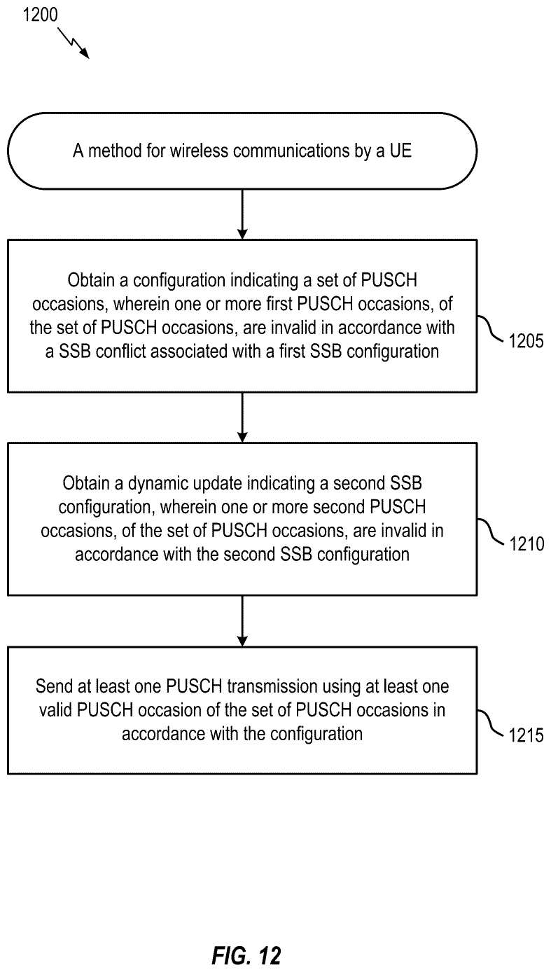

FIG. 12 shows a method 1200 for wireless communications by an apparatus, such as UE 104 of FIG. 1 or UE 304 of FIG. 3.

Method 1200 begins at block 1205 with obtaining a configuration indicating a set of PUSCH occasions, wherein one or more first PUSCH occasions, of the set of PUSCH occasions, are invalid in accordance with a SSB conflict associated with a first SSB configuration. Block 1205 may correspond to 1106 of FIG. 11.

Method 1200 then proceeds to block 1210 with obtaining a dynamic update indicating a second SSB configuration, wherein one or more second PUSCH occasions, of the set of PUSCH occasions, are invalid in accordance with the second SSB configuration. Block 1210 may correspond to 1112 of FIG. 11. It is beneficial for a UE and network entity to know when a SSB conflict may occur, so that the UE and network entity can plan around the SSB conflicts. A technical benefit of resolving these SSB conflicts is that the UE and the network entity may have a common understanding of which PUSCH occasions are valid, thereby reducing the occurrence of missed PUSCH transmissions or unnecessary (invalid) PUSCH transmission.

Method 1200 then proceeds to block 1215 with sending at least one PUSCH transmission using at least one valid PUSCH occasion of the set of PUSCH occasions in accordance with the configuration. Block 1215 may correspond to 1118 of FIG. 11.

In some aspects, an SSB associated with an invalid PUSCH occasion of the set of PUSCH occasions is invalid according to the second SSB configuration.

In some aspects, the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

In some aspects, the one or more first PUSCH occasions are valid in accordance with the second SSB configuration.

In some aspects, the one or more second PUSCH occasions are valid in accordance with the first SSB configuration.

In some aspects, the UE is in a RRC inactive state.

In some aspects, the RRC inactive state allows SDT via the set of PUSCH occasions.

In some aspects, method 1200 further includes obtaining an indication of the first SSB configuration.

In some aspects, the set of PUSCH occasions comprise Type-1 grant PUSCH occasions requested by the UE in an RRC connected state.

In some aspects, block 1210 includes obtaining the dynamic update indicating the second SSB configuration via at least one of an RRC release message, a dynamic grant for a new transmission, or a paging message.

In some aspects, the second SSB configuration comprises at least one adjustment of a periodicity of SSB signals from the first SSB configuration.

In some aspects, the second SSB configuration comprises a non-uniform omission of at least one SSB burst of the first SSB configuration.

In some aspects, the second SSB configuration comprises an adjustment to a number of SSB signals within an SSB burst.

In some aspects, the second SSB configuration comprises an adjustment to a cell DTX configuration of an SSB.

In some aspects, the second SSB configuration comprises an adjustment of at least one new SSB burst periodicity value.

In some aspects, the second SSB configuration comprises at least one new SSB burst.

In some aspects, the second SSB configuration comprises at least one new compact SSB burst.

In some aspects, the second SSB configuration comprises adapting a position of SSBs within an SSB burst.

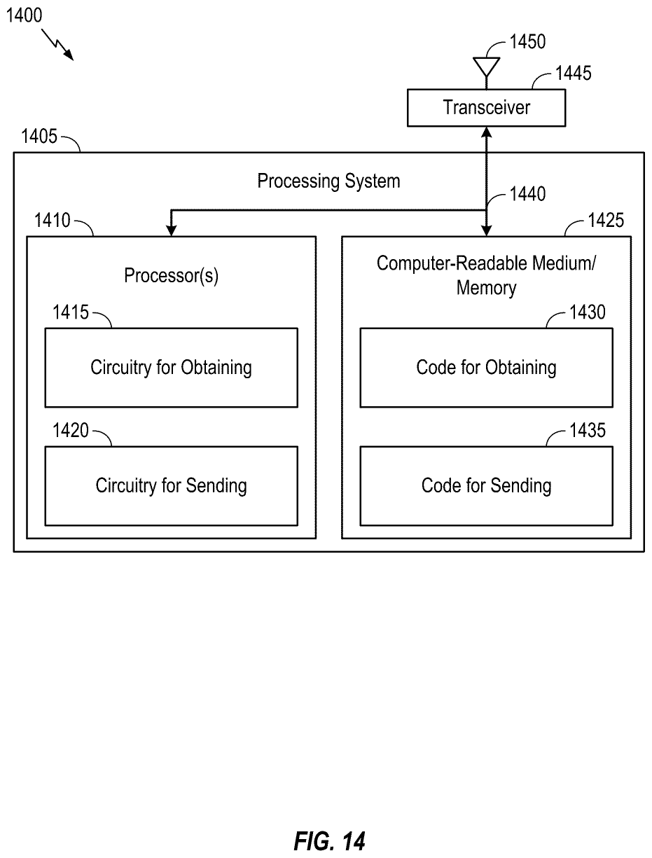

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Operations of a Network Entity

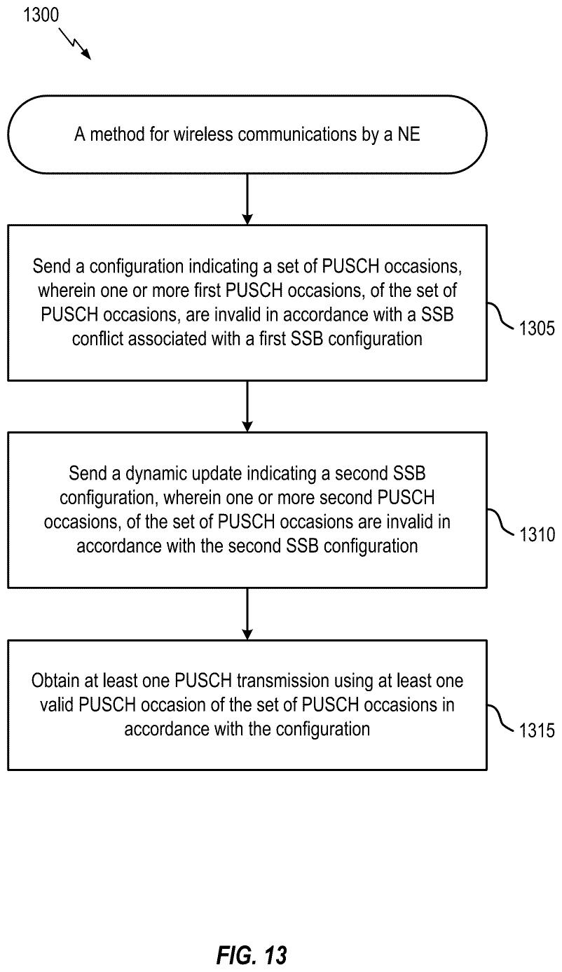

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with sending a configuration indicating a set of PUSCH occasions, wherein one or more first PUSCH occasions, of the set of PUSCH occasions, are invalid in accordance with a SSB conflict associated with a first SSB configuration. Block 1305 may correspond to 1106 of FIG. 11.

Method 1300 then proceeds to block 1310 with sending a dynamic update indicating a second SSB configuration, wherein one or more second PUSCH occasions, of the set of PUCH occasions are invalid in accordance with the second SSB configuration. Block 1310 may correspond to 1112 of FIG. 11. It is beneficial for a UE and network entity to know when an SSB conflict may occur, so that the UE and network entity can plan around the SSB conflicts. A technical benefit of resolving these SSB conflicts is that the UE and the network entity may have a common understanding of which PUSCH occasions are valid, thereby reducing the occurrence of missed PUSCH transmissions or unnecessary (invalid) PUSCH transmission.

Method 1300 then proceeds to block 1315 with obtaining at least one PUSCH transmission using at least one valid PUSCH occasion of the set of PUSCH occasions in accordance with the configuration. Block 1315 may correspond to 1118 of FIG. 11.

In some aspects, an SSB associated with an invalid PUSCH occasion of the set of PUSCH occasions is invalid according to the second SSB configuration.

In some aspects, the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

In some aspects, the one or more first PUSCH occasions are valid in accordance with the second SSB configuration.

In some aspects, the one or more second PUSCH occasions are valid in accordance with the first SSB configuration.

In some aspects, the at least one PUSCH transmission comprises SDT.

In certain aspects, method 1300 further includes sending an indication of the first SSB configuration.

In some aspects, the set of PUSCH occasions comprise Type-1 grant PUSCH occasions.

In some aspects, block 1310 includes sending the dynamic update indicating the second SSB configuration via at least one of an RRC release message, a dynamic grant in a new transmission, or a paging message.

In some aspects, the second SSB configuration comprises at least one adjustment in a periodicity of SSB signals from the first SSB configuration.

In some aspects, the second SSB configuration comprises a non-uniform omission of at least one SSB burst of the first SSB configuration.

In some aspects, the second SSB configuration comprises setting a number of SSB signals within an SSB burst.

In some aspects, the second SSB configuration comprises an adjustment to a cell DTX of an SSB.

In some aspects, the second SSB configuration comprises an adjustment of at least one new SSB burst periodicity value.

In some aspects, the second SSB configuration comprises an at least one new SSB burst.

In some aspects, the second SSB configuration comprises at least one new compact SSB burst.

In some aspects, the second SSB configuration comprises adapting a position of SSBs within an SSB burst.

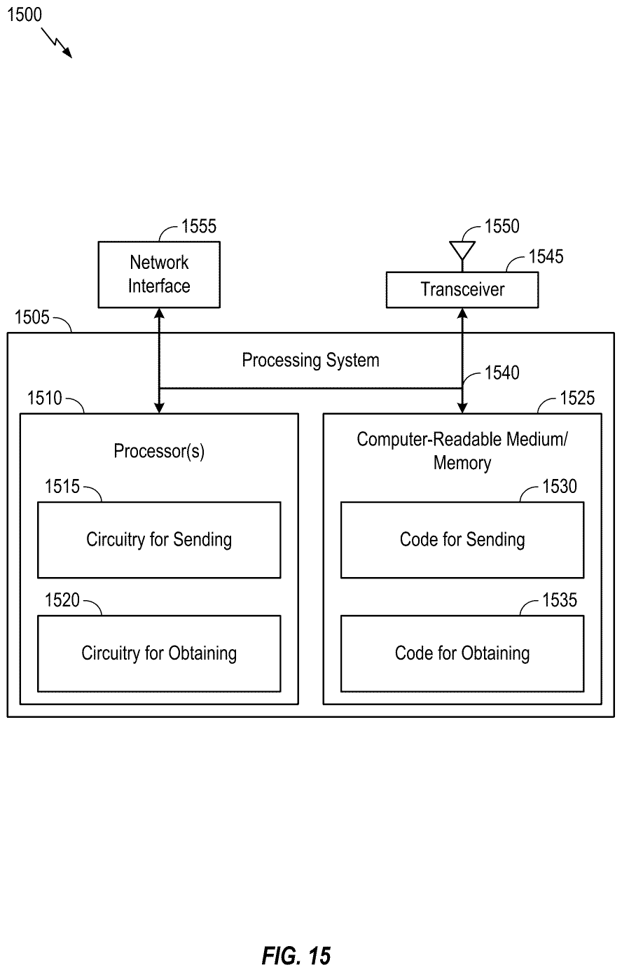

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for obtaining 1430 and code for sending 1435. Processing of the code 1430 and 1435 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry for obtaining 1415 and circuitry for sending 1420. Processing with circuitry 1415 and 1420 may enable and cause the communications device 1400 to perform the method 1200 described with respect to FIG. 12, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1525. In various aspects, one or more processors 1510 may be representative of the one or more processors 308, as described with respect to FIG. 3. The one or more processors 1510 are coupled to the computer-readable medium/memory 1525 via a bus 1540. In certain aspects, the computer-readable medium/memory 1525 is configured to store instructions (e.g., computer-executable code), including code 1530 and 1535, that when executed by the one or more processors 1510, cause the one or more processors 1510 to perform the method 1300 described with respect to FIG. 13, or any aspect related to it, including any operations described in relation to FIG. 13. The computer-readable medium/memory 1510 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1525 stores code (e.g., executable instructions), including code for sending 1530 and code for obtaining 1535. Processing of the code 1530 and 1535 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1525, including circuitry for sending 1515 and circuitry for obtaining 1520. Processing with circuitry 1515 and 1520 may enable and cause the communications device 1500 to perform the method 1300 described with respect to FIG. 13, or any aspect related to it.

Various components of the communications device 1500 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15. For example, means for indicating, setting, or adapting of the method 1300 described with respect to FIG. 13, or any aspect related to it, may include indicating, setting, or adapting.

### Example Clauses

Implementation examples are described in the following numbered clauses:

Clause 1: A method for wireless communications by a UE, comprising: obtaining a configuration indicating a set of PUSCH occasions, wherein one or more first PUSCH occasions, of the set of PUSCH occasions, are invalid in accordance with a SSB conflict associated with a first SSB configuration; obtaining a dynamic update indicating a second SSB configuration, wherein one or more second PUSCH occasions, of the set of PUSCH occasions, are invalid in accordance with the second SSB configuration; and sending at least one PUSCH transmission using at least one valid PUSCH occasion of the set of PUSCH occasions in accordance with the configuration.

Clause 2: The method of Clause 1, wherein an SSB overlaps a valid PUSCH occasion of the set of PUSCH occasions, that is valid according to the first SSB configuration, wherein the SSB overlaps the valid PUSCH occasion based at least in part on the second SSB configuration, and wherein the SSB is invalid.

Clause 3: The method of any one of Clauses 1-2, wherein the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

Clause 4: The method of any one of Clauses 1-3, wherein the one or more first PUSCH occasions are valid in accordance with the second SSB configuration.

Clause 5: The method of any one of Clauses 1-4, wherein the one or more second PUSCH occasions are valid in accordance with the first SSB configuration.

Clause 6: The method of any one of Clauses 1-5, wherein the UE is in a RRC inactive state.

Clause 7: The method of Clause 6, wherein the RRC inactive state allows SDT via the set of PUSCH occasions.

Clause 8: The method of any one of Clauses 1-7, further comprising obtaining an indication of the first SSB configuration.

Clause 9: The method of any one of Clauses 1-8, wherein the set of PUSCH occasions comprise Type-1 grant PUSCH occasions requested by the UE in an RRC connected state.

Clause 10: The method of any one of Clauses 1-9, wherein obtaining the dynamic update indicating the second SSB configuration comprises obtaining the dynamic update indicating the second SSB configuration via at least one of an RRC release message, a dynamic grant for a new transmission, or a paging message.

Clause 11: The method of any one of Clauses 1-10, wherein the second SSB configuration comprises at least one adjustment of a periodicity of SSB signals from the first SSB configuration.

Clause 12: The method of any one of Clauses 1-11, wherein the second SSB configuration comprises a non-uniform omission of at least one SSB burst of the first SSB configuration.

Clause 13: The method of any one of Clauses 1-12, wherein the second SSB configuration comprises an adjustment to a number of SSB signals within an SSB burst.

Clause 14: The method of any one of Clauses 1-13, wherein the second SSB configuration comprises an adjustment to a cell DTX configuration of an SSB.

Clause 15: The method of any one of Clauses 1-14, wherein the second SSB configuration comprises an adjustment of at least one new SSB burst periodicity value.

Clause 16: The method of any one of Clauses 1-15, wherein the second SSB configuration comprises at least one new SSB burst.

Clause 17: The method of any one of Clauses 1-16, wherein the second SSB configuration comprises at least one new compact SSB burst.

Clause 18: The method of any one of Clauses 1-17, wherein the second SSB configuration comprises adapting a position of SSBs within an SSB burst.

Clause 19: A method for wireless communications by a NE, comprising: sending a configuration indicating a set of PUSCH occasions, wherein one or more first PUSCH occasions, of the set of PUSCH occasions, are invalid in accordance with a SSB conflict associated with a first SSB configuration; sending a dynamic update indicating a second SSB configuration, wherein one or more second PUSCH occasions, of the set of PUSCH occasions are invalid in accordance with the second SSB configuration; and obtaining at least one PUSCH transmission using at least one valid PUSCH occasion of the set of PUSCH occasions in accordance with the configuration.

Clause 20: The method of Clause 19, wherein an SSB overlaps a valid PUSCH occasion of the set of PUSCH occasions, that is valid according to the first SSB configuration, wherein the SSB overlaps the valid PUSCH occasion based at least in part on the second SSB configuration, and wherein the SSB is invalid.

Clause 21: The method of any one of Clauses 19-20, wherein the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

Clause 22: The method of any one of Clauses 19-21, wherein the one or more first PUSCH occasions are valid in accordance with the second SSB configuration.

Clause 23: The method of any one of Clauses 19-22, wherein the one or more second PUSCH occasions are valid in accordance with the first SSB configuration.

Clause 24: The method of any one of Clauses 19-23, wherein the at least one PUSCH transmission comprises SDT.

Clause 25: The method of any one of Clauses 19-24, further comprising: sending an indication of the first SSB configuration.

Clause 26: The method of any one of Clauses 19-25, wherein the set of PUSCH occasions comprise Type-1 grant PUSCH occasions.

Clause 27: The method of any one of Clauses 19-26, wherein sending the dynamic update indicating the second SSB configuration comprises sending the dynamic update indicating the second SSB configuration via at least one of an RRC release message, a dynamic grant in a new transmission, or a paging message.

Clause 28: The method of any one of Clauses 19-27, wherein the second SSB configuration comprises at least one adjustment in a periodicity of SSB signals from the first SSB configuration.

Clause 29: The method of any one of Clauses 19-28, wherein the second SSB configuration comprises a non-uniform omission of at least one SSB burst of the first SSB configuration.

Clause 30: The method of any one of Clauses 19-29, wherein the second SSB configuration comprises setting a number of SSB signals within an SSB burst.

Clause 31: The method of any one of Clauses 19-30, wherein the second SSB configuration comprises an adjustment to a cell DTX of an SSB.

Clause 32: The method of any one of Clauses 19-31, wherein the second SSB configuration comprises an adjustment of at least one new SSB burst periodicity value.

Clause 33: The method of any one of Clauses 19-32, wherein the second SSB configuration comprises an at least one new SSB burst.

Clause 34: The method of any one of Clauses 19-33, wherein the second SSB configuration comprises at least one new compact SSB burst.

Clause 35: The method of any one of Clauses 19-34, wherein the second SSB configuration comprises adapting a position of SSBs within an SSB burst.

Clause 36: One or more apparatuses, comprising: one or more memories comprising executable instructions; and one or more processors configured to execute the executable instructions and cause the one or more apparatuses to perform a method in accordance with any one of Clauses 1-35.

Clause 37: One or more apparatuses configured for wireless communications, comprising: one or more memories; and one or more processors, coupled to the one or more memories, configured to cause the one or more apparatuses to perform a method in accordance with any one of Clauses 1-35.

Clause 38: One or more apparatuses configured for wireless communications, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: One or more apparatuses configured for wireless communications, comprising: a processing system that includes one or more processors and one or more memories coupled with the one or more processors, the processing system configured to cause the one or more apparatuses to perform a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system that includes one or more processors and one or more memories coupled with the one or more processors, the processing system configured to cause a user equipment (UE) to:
obtain a configuration indicating a set of physical uplink shared channel (PUSCH) occasions, wherein one or more first PUSCH occasions, of the set of PUSCH occasions, are invalid in accordance with a synchronization signal block (SSB) conflict associated with a first SSB configuration;
obtain a dynamic update indicating a second SSB configuration, wherein one or more second PUSCH occasions, of the set of PUSCH occasions, are invalid in accordance with the second SSB configuration; and
send at least one PUSCH transmission using at least one valid PUSCH occasion of the set of PUSCH occasions in accordance with the configuration.

2. The apparatus of claim 1 wherein an SSB overlaps a valid PUSCH occasion of the set of PUSCH occasions, that is valid according to the first SSB configuration, wherein the SSB overlaps the valid PUSCH occasion based at least in part on the second SSB configuration, and wherein the SSB is invalid.

3. The apparatus of claim 1, wherein the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

4. The apparatus of claim 1, wherein the one or more first PUSCH occasions are valid in accordance with the second SSB configuration.

5. The apparatus of claim 1, wherein the one or more second PUSCH occasions are valid in accordance with the first SSB configuration.

6. The apparatus of claim 1, wherein the UE is in a Radio Resource Control (RRC) inactive state and allows small data transfer (SDT) via the set of PUSCH occasions, wherein the at least one PUSCH transmission is in the RRC inactive state.

7. The apparatus of claim 1, wherein the processing system is further configured to cause the UE to obtain an indication of the first SSB configuration.

8. The apparatus of claim 1, wherein the set of PUSCH occasions comprise Type-1 grant PUSCH occasions requested by the UE in an RRC connected state.

9. The apparatus of claim 1, wherein to obtain the dynamic update indicating the second SSB configuration, the processing system is configured to obtain the dynamic update indicating the second SSB configuration via at least one of an RRC release message, a dynamic grant for a new transmission, or a paging message.

10. The apparatus of claim 1, wherein the second SSB configuration comprises at least one of:
at least one adjustment of a periodicity of SSB signals from the first SSB configuration,
a non-uniform omission of at least one SSB burst of the first SSB configuration,
an adjustment to a number of SSB signals within an SSB burst,
an adjustment to a cellular discontinuous transmission (cell DTX) configuration of an SSB,
an adjustment of at least one new SSB burst periodicity value,
at least one new SSB burst,
at least one new compact SSB burst, or
adapting a position of SSBs within an SSB burst.

11. An apparatus, comprising a processing system that includes one or more processors and one or more memories coupled with the one or more processors, the processing system configured to cause a network entity (NE) to:
send a configuration indicating a set of physical uplink shared channel (PUSCH) occasions, wherein one or more first PUSCH occasions, of the set of PUSCH occasions, are invalid in accordance with a synchronization signal block (SSB) conflict associated with a first SSB configuration;
send a dynamic update indicating a second SSB configuration, wherein one or more second PUSCH occasions, of the set of PUSCH occasions are invalid in accordance with the second SSB configuration; and
obtain at least one PUSCH transmission using at least one valid PUSCH occasion of the set of PUSCH occasions in accordance with the configuration.

12. The apparatus of claim 11, wherein an SSB associated with an invalid PUSCH occasion of the set of PUSCH occasions is invalid according to the second SSB configuration.

13. The apparatus of claim 11, wherein the one or more first PUSCH occasions are associated with no SSB conflict in accordance with the second SSB configuration, and wherein the one or more first PUSCH occasions remain invalid for the second SSB configuration in accordance with the SSB conflict associated with the first SSB configuration.

14. The apparatus of claim 11, wherein the one or more first PUSCH occasions are valid in accordance with the second SSB configuration.

15. The apparatus of claim 11, wherein the one or more second PUSCH occasions are valid in accordance with the first SSB configuration.

16. The apparatus of claim 11, wherein the at least one PUSCH transmission comprises small data transfer (SDT).

17. The apparatus of claim 11, wherein the processing system is further configured to cause the NE to send an indication of the first SSB configuration.

18. The apparatus of claim 11, wherein to send the dynamic update indicating the second SSB configuration, the processing system is configured to send the dynamic update indicating the second SSB configuration via at least one of an RRC release message, a dynamic grant in a new transmission, or a paging message.

19. The apparatus of claim 11, wherein the second SSB configuration comprises at least one of:
at least one adjustment of a periodicity of SSB signals from the first SSB configuration,
a non-uniform omission of at least one SSB burst of the first SSB configuration,
an adjustment to a number of SSB signals within an SSB burst,
an adjustment to a cellular discontinuous transmission (cell DTX) configuration of an SSB,
an adjustment of at least one new SSB burst periodicity value,
at least one new SSB burst,
at least one new compact SSB burst, or
adapting a position of SSBs within an SSB burst.

20. A method for wireless communications by a user equipment (UE), comprising:
obtaining a configuration indicating a set of physical uplink shared channel (PUSCH) occasions, wherein one or more first PUSCH occasions, of the set of PUSCH occasions, are invalid in accordance with a synchronization signal block (SSB) conflict associated with a first SSB configuration;
obtaining a dynamic update indicating a second SSB configuration, wherein one or more second PUSCH occasions, of the set of PUSCH occasions, are invalid in accordance with the second SSB configuration; and
sending at least one PUSCH transmission using at least one valid PUSCH occasion of the set of PUSCH occasions in accordance with the configuration.
